(19) United States
(12) Patent Application Publication
(10) Pub. No.: US 2025/0189730 A1
(43) Pub. Date: Jun. 12, 2025

(54) OPTICAL COUPLING PART AND OPTICAL SWITCH

(71) Applicant: NIPPON TELEGRAPH AND TELEPHONE CORPORATION, Tokyo (JP)

(72) Inventors: Chisato FUKAI, Musashino-shi, Tokyo (JP); Yoshiteru ABE, Musashino-shi, Tokyo (JP); Kazunori KATAYAMA, Musashino-shi, Tokyo (JP)

(73) Assignee: NIPPON TELEGRAPH AND TELEPHONE CORPORATION, Tokyo (JP)

(21) Appl. No.: 18/843,917

(22) PCT Filed: Mar. 23, 2022
(86) PCT No.: PCT/JP2022/013470

§ 371 Date: Sep. 4, 2024

(51) Int. Cl. G02B 6/38

(52) U.S. Cl. CPC G02B 6/3874; G02B 6/3871

(57) ABSTRACT

An object of the present disclosure is to provide an optical coupler and an optical switch capable of achieving stable optical characteristics with low power consumption and more economical efficiency with respect to external factors.

In order to achieve the above object,
the optical coupler according to the present disclosure includes
a first ferrule in which core centers of one or a plurality of single-core fibers are disposed on the same circumference from a center in a ferrule cross section, and which has an end face of a convex spherical shape in a direction of a ferrule center axis together with an end face of the single-core fiber;
a second ferrule in which core centers of the plurality of single-core fibers are disposed on a circumference having the same diameter as the circumference on which the core centers of the single-core fibers are disposed in the first ferrule from the center in the ferrule cross section, and which has an end face of a convex spherical shape in the direction of the center axis of the ferrule together with the end face of the single-core fiber; and
a cylindrical sleeve that has a hollow portion into which the first and second ferrules are inserted such that the ferrule center axes of the first ferrule and the second ferrule match, and the convex spherical end faces are opposite to each other, and in which a predetermined gap is provided between each outer diameter of the first ferrule and the second ferrule and an inner diameter of the hollow portion so that the first ferrule and the second ferrule are able to rotate.

### TECHNICAL FIELD

The present invention relates to an optical coupler used mainly for switching a path of an optical line using a single mode optical fiber in an optical fiber network, and an optical switch using the optical coupler.

### BACKGROUND ART

Various schemes have been proposed, for example, as disclosed in NPL 1, for all optical switches that perform path switching of light as it is. Of the optical switches, optical fiber type mechanical optical switches that control aligning of optical fibers or optical connectors by robot arms, motors, or the like are inferior to other systems in terms of a low switching speed, but are superior to the other systems in terms of low loss, low wavelength dependency, a multi-port property, and a self-holding function of holding a switching state when power is lost. As typical structures, for example, there are a scheme of moving a stage using optical fiber V-shaped grooves in parallel, a scheme of selectively coupling a plurality of optical fibers emitted from incident optical fibers by moving a mirror or a prism in parallel or changing an angle of the mirror or the prism, and a scheme of connecting a jumper cable with an optical connector using a robot arm.

Furthermore, a method of using a multi-core fiber as an optical path for switching has been proposed. For example, it is possible to collectively switch multiple routes by combining a three-dimensional MEMS optical switch with the multi-core fiber (for example, see NPL 2). Performing switching by rotating a cylindrical ferrule into which the multi-core fiber is inserted (for example, see PTL 1) makes optical components such as lenses and prisms unnecessary, and the configuration can be simplified.

### CITATION LIST

### Patent Literature

[PTL 1] Japanese Patent Application Publication No. H02-82212 (Fujitsu, removed without review)

### Non Patent Literature

[NPL 1]M. Ctepanosky, “A Comparative Review of MEMS-based Optical Cross-Connects for All-optical networks From the Past to the Present Day,” IEEE Communications Surveys & Tutorials, vol. 21, no. 3, pp. 2928-2946.2019.
[NPL 2]K. Hiruma, T. Sugawara, K. Tanaka, E. Nomoto, and Y. Lee, “Proposal of High-capacity and High-reliability Optical Switch Equipment with Multi-core Fibers,” 18th OptoElectronics and Communications Conference held jointly with 2013 International Conference on Photonics in Switching (OECC/PS), ThT1-2, 2013.
[NPL 3]B. Jian, “The Non-Contact Connector: A New Category of Optical Fiber Connector,” 2015 Optical Fiber Communications Conference and Exhibition (OFC), W2A. 1, 2015.
[NPL 4] Hajime Arao, Sho Yakabe, Fumiya Uehara, Dai Sasaki, Takayuki Shimazu, “FlexAirConnecT, Dust Insensitive Multi-Fiber Connector with Low Loss and Low Mating Force,” July 2018, SEI Technical Review, No. 193, pp. 26-31, 2018.

### SUMMARY OF INVENTION

### Technical Problem

However, the optical path switching described in NPL 1 has a problem that it is difficult to more reduce the power consumption and size, and to more economize. Concretely, in the above scheme of moving the stage using optical fiber V-shaped grooves or the prism in parallel generally uses a motor as a driving source, a certain level of torque or more is necessary for the motor due to a mechanism that directly move a weight object such as the stage, requiring power consumption for obtaining a corresponding output to maintain the necessary torque. Further, since an optical axis alignment using the single mode optical fiber requires accuracy of about 1 μm or less, in a mechanism for converting a rotary motion of the motor into a linear motion (in general, a ball screw is used), it is necessary to convert into the linear motion of sub μm steps. When it is considered that an optical fiber pitch of an optical fiber array on an output-side which is usually used is about 125 μm which is a cladding outer diameter of an optical fiber or about 250 μm which is the cladding outer diameter of the optical fiber, an actual driving time of the motor cannot but increase as an optical fiber array on the output-side increase in size, and thus there is a problem that power consumption increases. Therefore, an optical fiber type mechanical optical switch generally requires electric power of several hundred mW or more. In a robot arm scheme of using an optical connector, there is a problem that large electric power of several tens of W or more is required for the robot arm itself that controls insertion and extraction of an optical connector or a ferrule.

In optical path switching in which a multicore fiber described in NPL 2 is used, a collimating mechanism that performs coupling to an optical fiber array on the output-side and a vibration eliminating mechanism that obtains stable optical characteristics against external factors such as vibration are separately required in a process in which an optical switch is manufactured, and thus there is a problem that an assembling process also becomes complicated.

In optical path switching in which a cylindrical ferrule into which the multicore fiber disclosed in PTL 1 is inserted is used, a ferrule is closely inserted into a sleeve to align the center axis, and thus there is a problem that much energy for driving rotation is required and much power is necessary due to a frictional force between the ferrule and the sleeve. Further, in order to prevent deterioration in optical characteristics such as a connection loss due to damages occurring on facing fiber end faces when the ferrule rotates, a mechanism separating the ferrule end faces whenever the ferrule rotates is required, and energy unnecessary for driving rotation is required.

On the other hand, in a cylindrical ferrule into which an optical fiber is inserted, there is also a method of preventing the fiber end faces from being damaged due to contacts by using a connection form in which fibers are not brought into contact with each other by forming a gap in advance (for example, NPL 3). However, in order to suppress deterioration in a signal due to reflection caused by an air layer generated between the fiber end faces in the gap, a special coating for preventing reflection is required, and thus there is a problem that cost increases.

As another method of preventing reflection, there is a method for polishing a ferrule end face obliquely (for example, NPL 4). However, in the polished obliquely ferrule, there is a problem that interference of the ferrule end faces occurs during switching by rotation or a large gap is required, and thus there is a problem that a connection loss increases.

In order to solve the foregoing problems, an object of the present invention is to provide an optical coupler and an optical switch capable of achieving stable optical characteristics with low power consumption and more economical efficiency with respect to external factors.

### Solution to Problem

In order to achieve the foregoing objective, in the optical coupler and the optical switch of the present disclosure, end faces of two ferrules in which single-core fibers are disposed parallel to the ferrule center axis and at the same distance from the ferrule center axis have a convex spherical shape, the tips of the end faces of two ferrules are butted so that ferrule center axes match, and one of the ferrules is rotated around the ferrule center axis.

Specifically, an optical coupler according to the present disclosure includes:
a first ferrule in which core centers of one or a plurality of single-core fibers are disposed on the same circumference from a center in a ferrule cross section, and which has an end face of a convex spherical shape in a direction of a ferrule center axis together with an end face of the single-core fiber; a second ferrule in which core centers of the plurality of single-core fibers are disposed on a circumference having the same diameter as the circumference on which the core centers of the single-core fibers are disposed in the first ferrule from the center in the ferrule cross section, and which has an end face of a convex spherical shape in the direction of the center axis of the ferrule together with the end face of the single-core fiber; and
a cylindrical sleeve that has a hollow portion into which the first and second ferrules are inserted such that the ferrule center axes of the first ferrule and the second ferrule match, and the convex spherical end faces are opposite to each other, and in which a predetermined gap is provided between an outer diameter of each of the first ferrule and the second ferrule and an inner diameter of the hollow portion so that the first ferrule and the second ferrule are able to rotate.

For example, in the optical coupler according to the present disclosure,
in each of the first ferrule and the second ferrule, an angle formed by a cross section perpendicular to the ferrule center axis and an end face of the single-core fiber may be 4.5 degrees or more.

For example, in the optical coupler according to the present disclosure,
a gap between the end face of the single-core fiber of the first ferrule and the end face of the single core fiber of the second ferrule whose optical axis matches with the single-core fiber may be 20 μm or less.

For example, in the optical coupler according to the present disclosure,
a distance of the core center of each single-core fiber in the first ferrule and the second ferrule from the ferrule center may be 250 μm or less.

For example, in the optical coupler according to the present disclosure,
in each of the first and second ferrules, a radius of curvature in the convex spherical shape may be 0.5 mm to 3.2 mm.

Specifically, an optical switch according to the present disclosure includes
the optical coupler; and
a rotational mechanism configured to rotate one of the first and second ferrules of the optical coupler about the ferrule center axis.

For example, the optical switch according to the present disclosure further includes:
an actuator configured to rotate the rotational mechanism at a given angular step and stop the rotational mechanism at an arbitrary angular step; and
a bearing forming the rotational mechanism.

According to the present invention, the end faces of two ferrules in which single-core fibers are arranged parallel to the ferrule center axis and at the same distance from the ferrule center axis have a convex shape, and because the tips of the end faces of two ferrules are butted so that ferrule center axes match and one of the ferrules is rotated around the ferrule center axes, the end faces of opposite optical fibers do not come into contact with each other, and it is possible to prevent deterioration of optical properties such as splice loss due to scratches on the end faces of the optical fibers due to contact. Since a reflection amount of light can be reduced by causing the end faces of the facing optical fibers not to be parallel with each other, a more economical optical coupler and optical switch can be provided without requiring reflection coating.

Further, according to the present invention, since one of the input-side and the output-side of the optical coupler for performing optical switching is formed as an axially rotatable mechanism, energy required for the actuator, that is, a torque output can be made very small and power consumption can be reduced. Since an optical axis deviation amount in a direction other than axial rotation of the input-side ferrule is guaranteed by the sleeve in the optical coupler, a loss can be reduced. In addition, according to the present invention, miniaturization and economic efficiency can be achieved because a collimator or a special ant-vibration mechanism is not included and optical connection components such as a ferrule and a sleeve which are generally used are configured.

The above inventions can be combined as much as possible.

### Advantageous Effects of Invention

According to the present disclosure, it is possible to provide an optical coupler and an optical switch capable of achieving stable optical characteristics with low power consumption and more economical efficiency with respect to external factors.

### BRIEF DESCRIPTION OF DRAWINGS

FIG. 1 shows an example of a use pattern of the present invention.

FIG. 2 shows an example of a schematic configuration according to the present invention.

FIG. 3 is a front view showing an end face of an input-side ferrule.

FIG. 4 is a front view showing an end face of an output-side ferrule.

FIG. 5 is a diagram showing an optical coupler on a plane along a longitudinal direction.

FIG. 6 shows an example of a relationship between an excessive loss and a clearance between a ferrule outer diameter and a sleeve inner diameter.

FIG. 7 is a diagram showing the vicinity of a ferrule end of the optical coupler according to the present invention.

FIG. 8 shows an example of a relationship between the angle between a cross section perpendicular to a ferrule center axis and an end face of a single-core fiber, and an amount of reflection attenuation amount.

FIG. 9 shows an example of a relationship of an excessive loss and a gap of the optical fiber.

FIG. 10 shows an example of a relationship between the distance from the ferrule tip to the single-core fiber end face with respect to the radius of curvature of the end face of the ferrule having a convex spherical shape.

FIG. 11 shows an example of a relationship between the distance from the ferrule tip to the single-core fiber end face with respect to the radius of curvature of the end face of the ferrule having a convex spherical shape.

FIG. 12 is a diagram showing an example of a relationship between the core arrangement radius and an excessive loss due to rotational angle deviation.

FIG. 13 is a diagram showing a fitting form of the optical coupler according to Embodiment 1 of the present invention.

FIG. 14 is a diagram showing a fitting form of the optical coupler according to Embodiment 2 of the present invention.

FIG. 15 is a diagram showing a cross-section of an input-side ferrule of the optical coupler according to the Embodiment 2 of the present invention.

FIG. 16 is a diagram showing a cross-section of an input-side ferrule of the optical coupler according to the Embodiment 2 of the present invention.

FIG. 17 is a diagram showing a cross-section of an output-side flange according to the Embodiment 1 of the present invention.

FIG. 18 is a diagram showing a side face of the output-side flange according to the Embodiment 1 of the present invention.

### DESCRIPTION OF EMBODIMENTS

Embodiments of the present disclosure will be described hereinafter in detail with reference to the drawings. The present invention is not limited to the embodiments to be described below. These embodiments are merely exemplary and the present disclosure can be implemented in various modified and improved modes based on the knowledge of those skilled in the art. Constituent elements with the same reference signs in the present specifications and the drawings are identical to each other.

### Embodiment 1

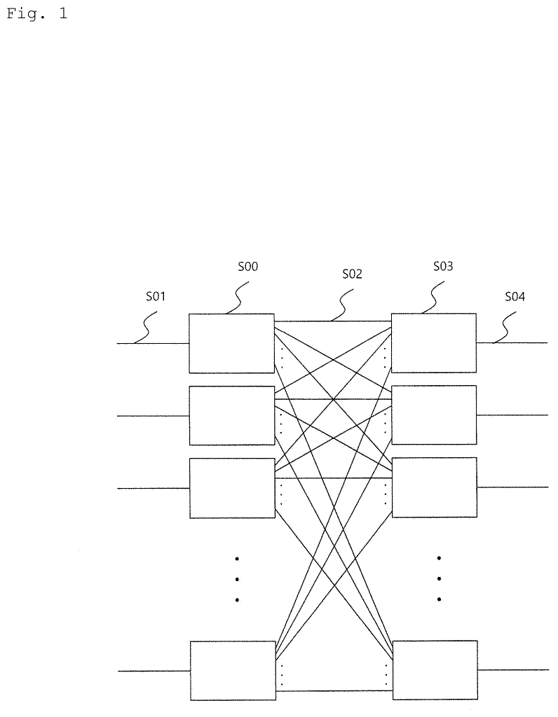

FIG. 1 is a diagram showing an example of an embodiment according to the present invention. In the present embodiment, a mode in which light is incident from an input-side optical fiber S01 and is emitted to an output-side optical fiber S04 will be described, but a direction of light may be reverse. In the present invention, the input-side optical fiber S01 connected to the front-stage optical switch constituent unit S00 is switched to a specific port of an optical fiber S02 between optical switches in the front-stage optical switch constituent unit S00, and the port of the optical fiber S02 between the optical switches can be switched to a desired output-side optical fiber S04 in a rear-stage optical switch constituent unit S03. The present invention relates to an optical switch corresponding to a front-stage optical switch constituent unit S00 and a rear-stage optical switch constituent unit S03. Hereinafter, the front-stage optical switch constituent unit S00 is abbreviated as the optical switch S00, and the rear-stage optical switch constituent unit S03 is abbreviated as the optical switch S03. Since the optical switch S00 and the optical switch S03 are in a horizontal reversion relation and have the same configuration, a detailed configuration of the optical switch S00 will be described.

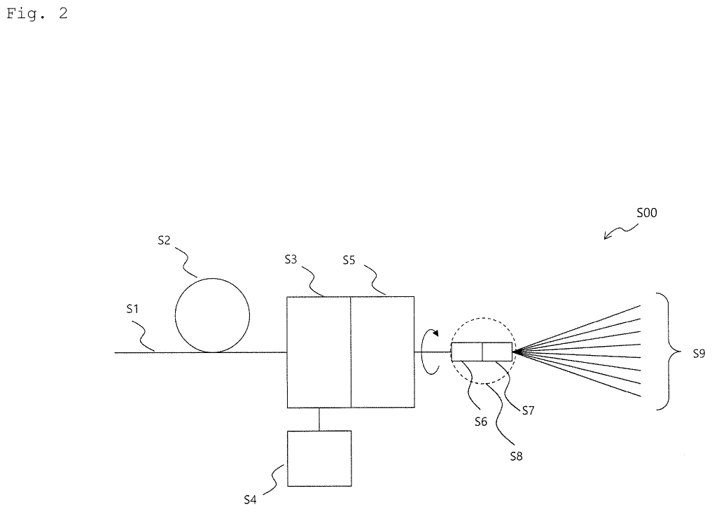

FIG. 2 is a block diagram showing a configuration according to an embodiment of the present invention.

An optical coupler S8 included in the optical switch S00 according to the present embodiment includes:
a first ferrule in which core centers of one or a plurality of single-core fibers are disposed on the same circumference from a center in a ferrule cross section, and which has an end face of a convex spherical shape in a direction of a ferrule center axis together with an end face of the single-core fiber;
a second ferrule in which core centers of a plurality of single-core fibers are disposed on a circumference having the same diameter as the circumference on which the core centers of the single-core fibers are disposed in the first ferrule from the center in the ferrule cross section, and which has an end face of a convex spherical shape in the direction of the center axis of the ferrule together with the end face of the single-core fiber; and
a cylindrical sleeve S17 that has a hollow portion into which the first and second ferrules are inserted such that the ferrule center axes of the first ferrule and the second ferrule match, and the convex spherical end faces are opposite to each other, and in which a predetermined gap is provided between each outer diameter of the first ferrule and the second ferrule and an inner diameter of the hollow portion so that the first ferrule and the second ferrule are able to rotate. In FIG. 2, an input-side optical fiber S1 is formed from one single-core fiber, and an input-side ferrule S6 is set as a first ferrule. An output-side optical fiber S9 is formed from a plurality of single-core fibers, and an output-side ferrule S7 is set as a second ferrule. The input-side optical fiber S1 corresponds to the input-side optical fiber S01 in FIG. 1, and the output-side optical fiber S9 corresponds to the optical fiber S02 between optical switches in FIG. 1. In the following description, “the end face of the single-core fiber” is abbreviated as “the single-core fiber end face”.

The optical switch S00 shown in FIG. 2 has the optical coupler S8 that includes an input-side ferrule S6 into which the input-side optical fiber S1 is inserted and an output-side ferrule S7 into which the output-side optical fiber S9 is inserted. The optical switch is the optical switch S00 in which, when light is incident from the input-side optical fiber S1, the input-side optical fiber S1 is connected to any one core of the output-side optical fiber S9 by fixing the output-side ferrule S7 and rotating the input-side ferrule S6, and the incident light can be output from one core of the output-side optical fiber S9 and which can be used as a 1×N relay optical switch. Conversely, light can also be incident from the output-side optical fiber S9. For example, by causing light to be incident on a plurality of single-core fibers among the output-side optical fibers S9, fixing the output-side ferrule S7, and rotating the input-side ferrule S6, any one core of the output-side optical fiber S9 can be connected to the input-side optical fiber S1, and only one light selected from the plurality of pieces of incident light can be output from the input-side optical fiber S1. As shown in FIG. 1, by combining the plurality of optical switches, it is possible to configure an N×N optical switches. Here, the output-side ferrule S7 is fixed and the input-side ferrule S6 is rotated. However, since switching of the facing fibers is enabled by fixing either the input-side ferrule S6 or the output-side ferrule S7 and rotating the facing side, the input-side ferrule S6 may be fixed and the output-side ferrule S7 may be rotated. Further, although the input-side ferrule S6 is one core, a plurality of optical fibers can also be disposed.

An optical switch S00 in which the output-side ferrule S7 is fixed and the input-side ferrule S6 is rotated will be described below. The output-side ferrule S7 is fixed by a rotation stop mechanism (not shown) so as not to be axially rotated. An actuator S3 performs arbitrary angle rotation according to a signal from a control circuit S4. The input-side ferrule S6 rotates when an output of the actuator S3 is transmitted via the rotational mechanism S5. The input-side ferrule S6 is provided with an extra long portion S2 for allowing for twisting of the input-side optical fiber S1. The optical coupler S8 is configured to suppress axial deviation by an axial deviation adjustment mechanism (not shown), and to avoid excessive loss due to the axial deviation.

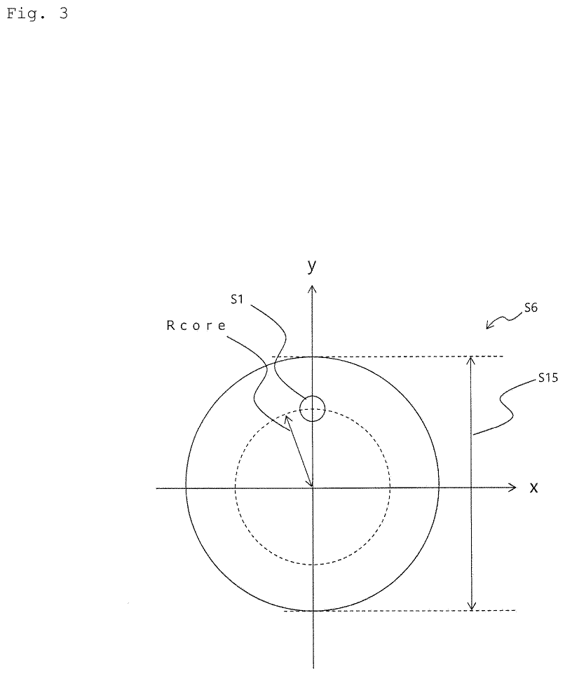

FIG. 3 is a schematic view showing the end face of the input-side ferrule S6 according to the embodiment of the present invention from the front. The present invention is characterized in that a core center of the input-side optical fiber S1 is disposed on a circumference of a circle having a core arrangement radius Rcore with respect to a center of the input-side ferrule S6, as shown in FIG. 3. Although an example in which the input-side optical fiber S1 of one core is disposed on a y-axis (x=0) is shown in FIG. 3, the core center of the input-side optical fiber S1 may be disposed on the circumference of the circle having the core arrangement radius Rcore, and the present invention is not limited thereto.

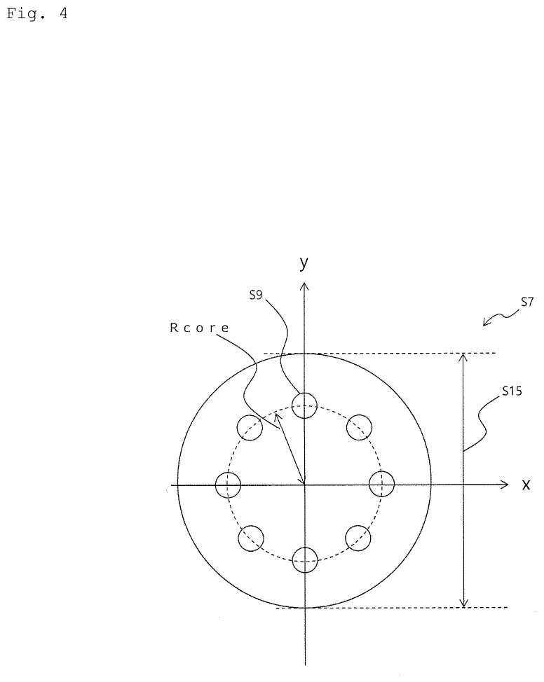

FIG. 4 is a schematic view showing the end face of the output-side ferrule S7 according to the embodiment of the present invention from the front. As shown in the drawing, the core centers of the plurality of output-side optical fibers S9 are each disposed on the circumference of a circle with the core arrangement radius Rcore with respect to the center of the output-side ferrule S7. In FIG. 4, an example in which eight output-side optical fibers S9 are disposed in total is given, but the core centers of the plurality of output-side optical fibers S9 may be disposed on the circumference of a circle with the core arrangement radius Rcore, and the present invention is not limited thereto.

It is important to reduce a transmission loss of the optical coupler S8 as much as possible, and the cores of the output-side optical fibers S9 preferably have the same optical characteristics in that a mode field diameter is approximately the same degree as the core of the input-side optical fiber S1. Further, it is important to minimize an excessive loss due to axial deviation, and it is preferable that the ferrule outer diameter S15 of the output-side ferrule S7 be approximately the same as the ferrule outer diameter S15 of the input-side ferrule S6.

In this embodiment, the input-side ferrule S6 and the output-side ferrule S7 are made of zirconia, and the input-side optical fiber S1 and the output-side optical fiber S9 are made of quartz glass, but the present invention is not limited thereto, as long as the optical fiber can communicate signal light of a communication wavelength band.

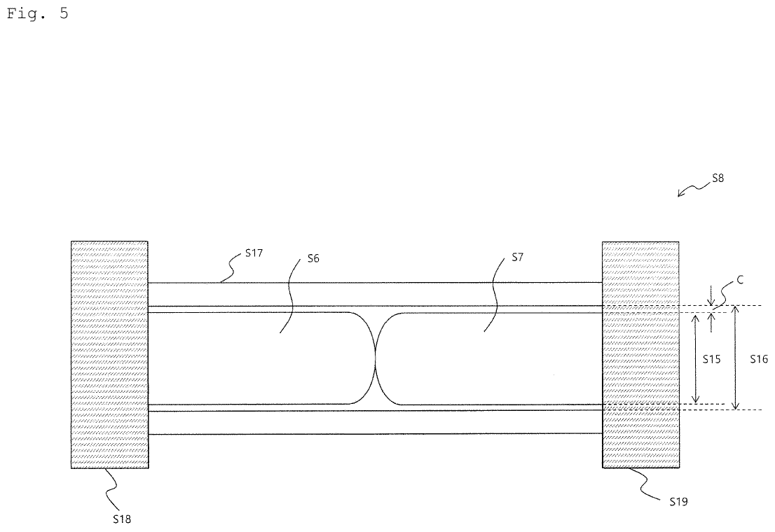

FIG. 5 is a schematic view showing the optical coupler S8 on a plane in a longitudinal direction according to an embodiment of the present invention. The input-side ferrule S6 into which the input-side optical fiber S1 is inserted and the output-side ferrule S7 into which the output-side optical fiber S9 is inserted are aligned by the cylindrical sleeve S17 that has an inner diameter S16 which is slightly by about sub-μm larger than a ferrule outer diameter S15 of the ferrules. A slight clearance C of about sub-μm is provided for the input-side ferrule S6 and the output-side ferrule S7 so that axial deviation is controlled with a given allowable range and the axial rotation of the input-side ferrule S6 is not obstructed.

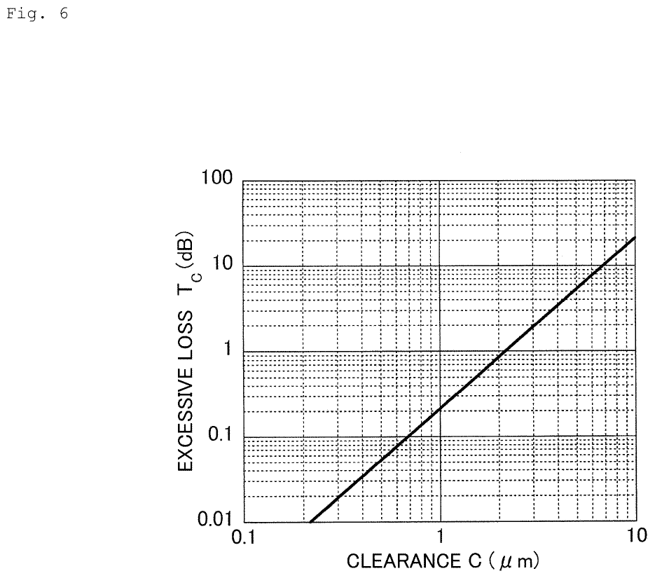

FIG. 6 is a diagram showing an example of a relationship between a clearance C between the ferrule outer diameter S15 and the sleeve inner diameter S16 of the input-side ferrule S6 and the output-side ferrule S7 and an excessive loss T_{c}. In optical coupling between optical fibers, axial misalignment of fiber cores causes the excessive loss. Since an increase in the excessive loss is a factor that limits a total length of the optical path, it is necessary to reduce the axial misalignment of the fiber core. Here, since the clearance C between the ferrule outer diameter S15 and the sleeve inner diameter S16 corresponds to the axial misalignment of the fiber core, a relationship between the clearance C (unit: μm) between the ferrule outer diameter S15 and the sleeve inner diameter S16 and the excessive loss T_{c} (unit: dB) can be expressed in Math. 1.

$$\begin{matrix}[ Math . 1 ] & \\ {T}_{C} = - 10 \times log \{ {( \frac{2 {ω}_{1} {ω}_{2}}{{ω}_{1}^{2} + {ω}_{2}^{2}} )}^{2} exp [ - 1 \times \frac{2 {C}^{2}}{{ω}_{1}^{2} + {ω}_{2}^{2}} ] \} & ( 1 )\end{matrix}$$

Here, ω₁ and ω₂ are mode field radii (unit: μm) of the input-side and output-side optical fibers S9 cores, respectively. FIG. 6 is a diagram showing a loss when the mode field diameters of the input-side optical fibers S1 and output-side optical fibers S9 cores are both 9 μm. For example, when the ferrule outer diameter S15 and sleeve inner diameter S16 are machined so that the clearance C is 0.7 μm or less, the maximum excessive loss can be suppressed to about 0.1 dB or less. Further, when the maximum excessive loss is set to 0.2 dB, it is necessary to machine the ferrule outer diameter S15 and the sleeve inner diameter S16 so that the clearance C becomes 1 μm or less.

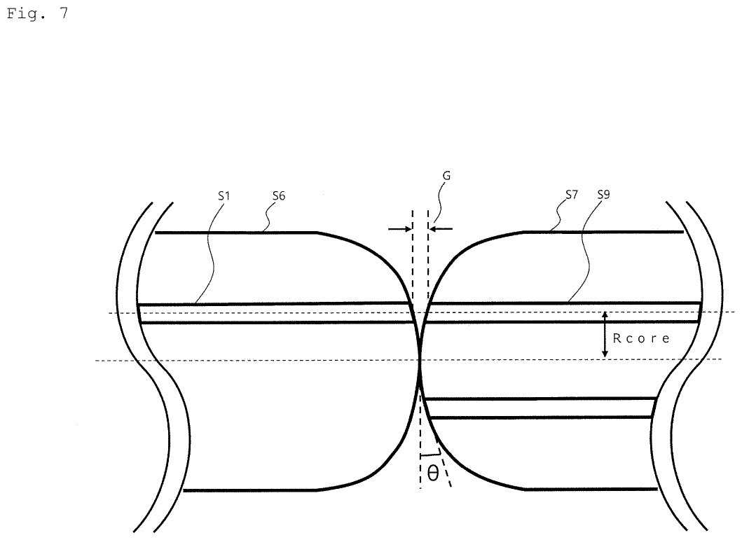

FIG. 7 is a schematic diagram showing the vicinity of the end of the ferrule of the optical coupler S8 in more detail according to the embodiment of the present invention. The end faces of the input-side ferrule S6 and the output-side ferrule S7 have a convex spherical shape in the ferrule center axial direction. The tips of each of the input-side ferrule S6 and the output-side ferrule S7 are abutted. As described above, the input-side fiber S1 and the output-side fiber S9 are disposed at the positions of the core arrangement radius Rcore in the ferrule cross section. The input-side fiber S1 and the output-side fiber S9 have end faces retreated from the tips to prevent the respective end faces from being damaged due to contact at the time of switching by rotation. At the end faces of the input-side fiber S1 and the output-side fiber S9, an angle θ formed between the cross section perpendicular to the ferrule center axis and the single-core fiber end face is controlled to suppress deterioration of signal characteristics due to reflection.

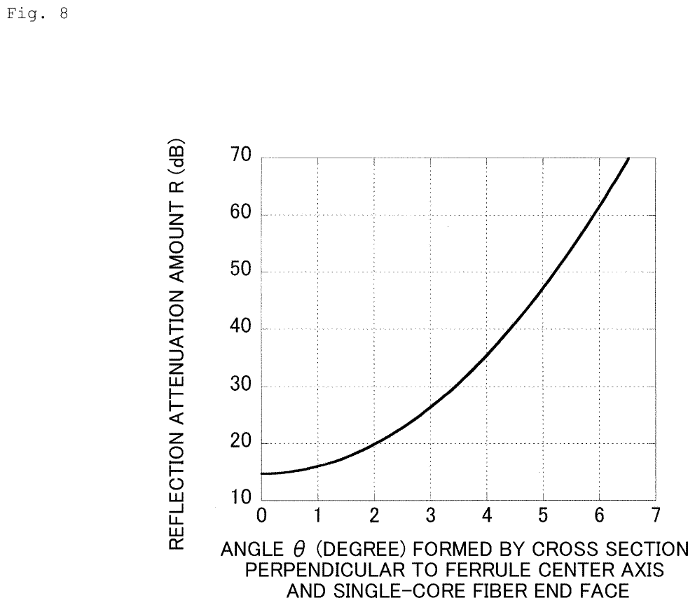

FIG. 8 is a diagram showing an example of the relationship between the angle θ formed by the cross section perpendicular to the ferrule center axis and the single-core fiber end face and a reflection attenuation amount R. When there is a region with a different refractive index between the end face of the input-side optical fiber S1 and the end face of the output-side optical fiber S9 in the optical coupler S8, the signal characteristics are degraded due to reflection. In the configuration of the present invention shown in FIG. 7, since there is a gap G between the end face of the input-side optical fiber S1 and the end face of the output-side optical fiber S9, and quartz glass and air have different refractive index, it is necessary to devise a way of reducing the reflection. In the present invention, reflection is reduced by controlling the angle θ. The relationship between the angle θ (unit: degree) formed by the cross section perpendicular to the ferrule center axis and the single-core fiber end face and the reflection attenuation amount R (unit: dB) can be expressed by the equation 2.

$$\begin{matrix}[ Math . 2 ] & \\ R = 10 \frac{{( π \times {n}_{1} \times {ω}_{1} )}^{2}}{{λ}^{2}} \times log ( e ) \times {( 4 π \frac{θ}{360} )}^{2} + {R}_{0} & ( 2 )\end{matrix}$$

Here, n₁, ω₁, and λ are a refractive index of each optical fiber, a mode field radius of an optical fiber core (unit: μm), and a wavelength of propagating light in vacuum (unit: μm), respectively. R₀ (unit: dB) is a reflection attenuation amount at a flat end face and can be expressed as in equation (3).

$$\begin{matrix}[ Math . 3 ] & \\ {R}_{0} = - 10 \times log [ {( \frac{{n}_{1} - {n}_{2}}{{n}_{1} + {n}_{2}} )}^{2} ] & ( 3 )\end{matrix}$$

Where n₂ is a refractive index of a light reception medium, that is, a refractive index of air. In this embodiment, when the wavelength λ is 1,310 nm and the mode field radius ω₁ is 4.5 μm, the reflection attenuation amount R₀ at the flat end face is 14.7 dB, and for example, by setting the angle between the cross section perpendicular to the ferrule center axis and the single-core fiber end face to 4.5 degrees or more, a reflection attenuation amount R of 40 dB or more can be maintained.

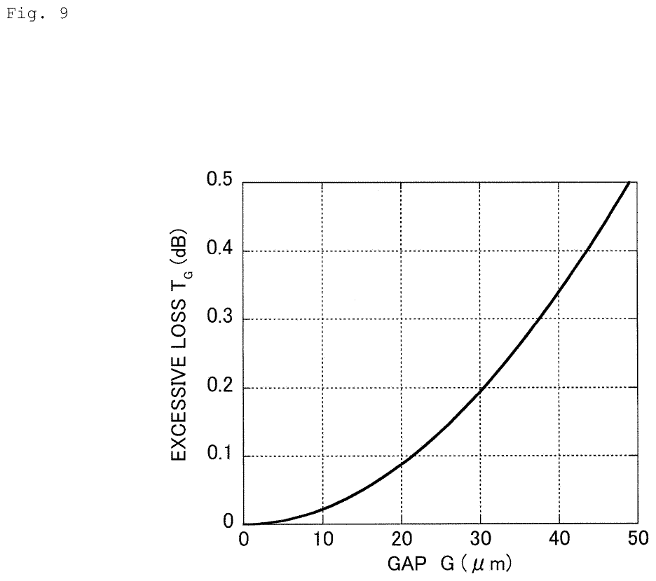

FIG. 9 is a diagram showing an example of a relationship between the gap G and an excessive loss T_{G}. In optical coupling between the input-side optical fiber S1 and the output-side optical fiber S9, when there is a gap G between the end face of the input-side optical fiber S1 and the end face of the output-side optical fiber S9, a distribution of emitted light of the input-side optical fiber S1 spreads and coupling efficiency with the core of the output-side optical fiber S9 decreases, and thus, excessive loss is caused. The relationship between the gap G (unit: μm) and the excessive loss T_{G} (unit: dB) can be expressed by equation 4.

$$\begin{matrix}[ Math . 4 ] & \\ & ( 4 )\end{matrix}$$

$${T}_{G} = - 10 \times log \{ \frac{4 [ 4 {( \frac{G λ}{2 π {n}_{clad} {ω}_{1} {ω}_{2}} )}^{2} + \frac{{ω}_{1}^{2}}{{ω}_{2}^{2}} ]}{{[ 4 {( \frac{G λ}{2 π {n}_{clad} {ω}_{1} {ω}_{2}} )}^{2} + \frac{{ω}_{2}^{2} + {ω}_{1}^{2}}{{ω}_{2}^{2}} ]}^{2} + 4 {( \frac{G λ}{2 π {n}_{clad} {ω}_{1} {ω}_{2}} )}^{2} \frac{{ω}_{2}^{2}}{{ω}_{1}^{2}}} \}$$

Here, n_{clad}, ω₁ and ω₂ are the wavelength of the propagating light in vacuum (unit: μm), the refractive index of the optical fiber cladding, that is, pure silica, and the mode field radius (unit: μm) of the cores of the input-side optical fiber S1 and the output-side optical fiber S9, respectively. FIG. 9 is a diagram showing a loss when the mode field diameters of the cores of the input-side optical fiber S1 and the output-side optical fiber S9 are both 9 μm. For example, by adjusting the gap G between the end face of the input-side optical fiber S1 and the end face of the output-side optical fiber S9 to 22 μm or less, the excessive loss can be suppressed to 0.1 dB or less.

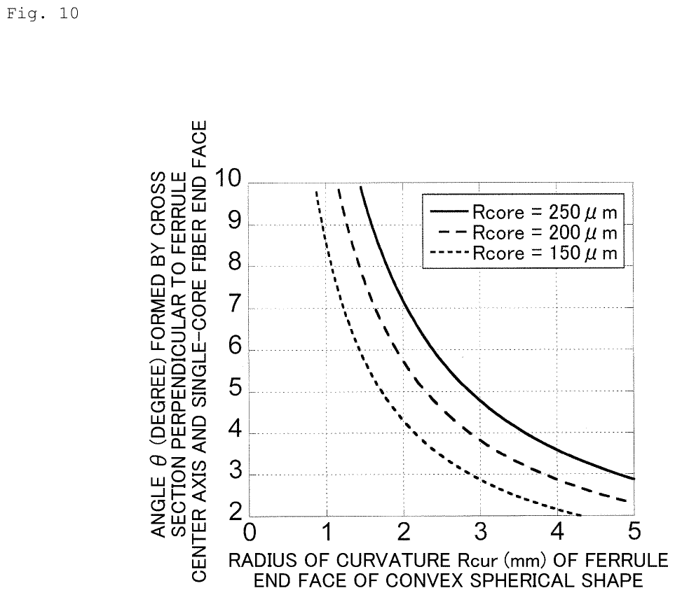

FIG. 10 is a diagram showing an example of the relationship between the angle θ formed by the cross section perpendicular to the ferrule center axis and the single-core fiber end face with respect to the radius of curvature Rcur of the ferrule end face having the convex spherical shape. The relationship between the radius of curvature Rcur (unit: mm) of the ferrule end face of the convex spherical shape and the angle θ (unit: degree) formed by the cross section perpendicular to the ferrule center axis and the single-core fiber end face can be expressed by equation 5, using the core arrangement radius Rcore (unit: μm).

$$\begin{matrix}[ Math . 5 ] & \\ {R}_{cur} = \frac{{R}_{core}}{sin θ} & ( 5 )\end{matrix}$$

FIG. 10 is a diagram showing the relationship between the angle θ and the radius of curvature Rcur when the core arrangement radius Rcore is 150, 200, and 250 μm. It can be seen from FIG. 8 that the angle θ that can maintain the reflection attenuation amount R of 40 dB or more is 4.5 degrees or more, and it is possible to realize a radius of curvature Rcur in which the angle θ is 4.5 degrees or more in the core arrangement radius Rcore of 250 μm or less. For example, when the core arrangement radius Rcore is 150 μm, 200 μm, and 250 μm, by adjusting the radius of curvature Rcur to be 1.9 mm or less, 2.5 mm or less, and 3.2 mm or less, the angle θ becomes 4.5 degrees or more and the reflection attenuation amount R can be maintained at 40 dB or more.

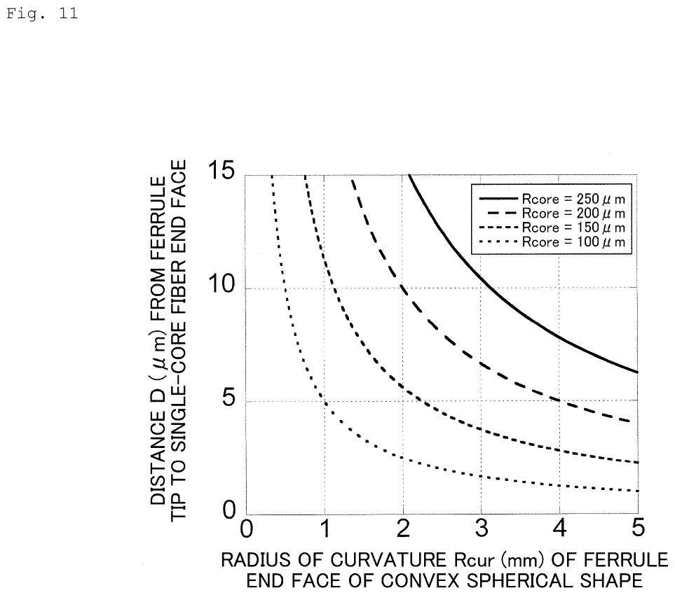

FIG. 11 is a diagram showing an example of the relationship between the radius of curvature Rcur of the ferrule end face of the convex spherical shape and the distance D from the ferrule tip to the single-core fiber end face. The distance D from the ferrule tip to the single-core fiber end face corresponds to a half of a gap G between the end face of the input-side optical fiber S1 and the end face of the output-side optical fiber S9, and can be expressed in equation 6, using the radius of curvature Rcur (unit: mm) of the ferrule end face of the convex spherical shape and the angle θ (unit: degree) formed between the cross section perpendicular to the ferrule center axis and the single-core fiber end face.

$$\begin{matrix}[ Math . 6 ] & \\ D = \frac{G}{2} = {R}_{cur} - ( {R}_{cur} \times cos θ ) & ( 6 )\end{matrix}$$

FIG. 11 shows the relationship between the radius of curvature Rcur and the distance D from the ferrule tip to the fiber end face when the core arrangement radius Rcore is 150, 200, and 250 μm. For example, when the core arrangement radius Rcore is 100 μm, 150 μm, 200 μm, and 250 μm, by adjusting the radius of curvature Rcur to be 0.5 mm or more, 1.1 mm or more, 2.0 mm or more, and 3.1 mm or more, the distance D from the ferrule tip to the fiber end face is 10 μm or less, that is, the gap G is 20 μm or less, and as shown in FIG. 9, the excessive loss T_{G} due to the gap can be suppressed to 0.1 dB or less.

In the optical coupler S8 included in the optical switch S00 according to the present embodiment, to obtain a reflection attenuation amount of 40 dB or more and an excessive loss due to the gap of 0.1 dB or less, in each of the input-side ferrule S6 and the output-side ferrule S7, the radius of curvature in the convex spherical shape may be from 0.5 mm to 3.2 mm.

Next, requirements related to the actuator S3 shown in FIG. 2, the input-side ferrule S6 shown in FIG. 3, and the output-side ferrule S7 shown in FIG. 4 will be described. The actuator S3 is a driving mechanism which rotates at any angle step in accordance with a pulse signal from the control circuit S4 and has a given stationary torque at each angle step. For example, a stepping motor is used. As long as the actuator S3 is a driving mechanism that performs rotation at any angle step in accordance with a pulse signal from the control circuit S4 and has a given stationary torque at each angle step, any other method may be used. A rotational speed and a rotational angle are determined by a period and the number of pulses of a pulse signal from the control circuit S4, and the angle step and the stationary torque may be adjusted via a reduction gear. Since the input-side ferrule S6 in the optical coupler S8 is designed to rotate axially, as described, the actuator S3 applies a stationary torque necessary for holding a rotational angle of the input-side ferrule S6.

Thus, it is possible to provide that optical switch that has a self-holding function in which power is not necessary in stopping after switching, is capable of reducing driving energy as much as possible in switching of an optical path, and consumes low power.

Here, in a stepping motor, when the number of angle steps in which an angle position is held during stopping of power supply is defined as the number of stationary angle steps, the number of stationary angle steps is a natural number multiple of the number of cores with the same core arrangement radius Rcore as the output-side optical fiber S9.

When the excessive loss due to the rotational angle deviation in the optical coupler S8 is defined as T_{R} (unit: dB), the rotational angle deviation related to a stationary angle accuracy of the stepping motor is defined as Φ(unit: °), the core arrangement radius is defined as Rcore (unit: μm), and the mode field radii of the cores of the input-side optical fiber S1 and the output-side optical fiber S9 are defined as ω₁ and ω₂ (unit: μm), respectively, a relation thereof can be expressed as in equation 7.

$$\begin{matrix}[ Math . 7 ] & \\ {T}_{R} = - 10 log \{ {( \frac{2 {ω}_{1} {ω}_{2}}{{ω}_{1}^{2} + {ω}_{2}^{2}} )}^{2} exp [ - 1 \times \frac{2 {( 2 {R}_{core} sin 2 π \frac{Φ}{360} )}^{2}}{{ω}_{1}^{2} + {ω}_{2}^{2}} ] \} & ( 7 )\end{matrix}$$

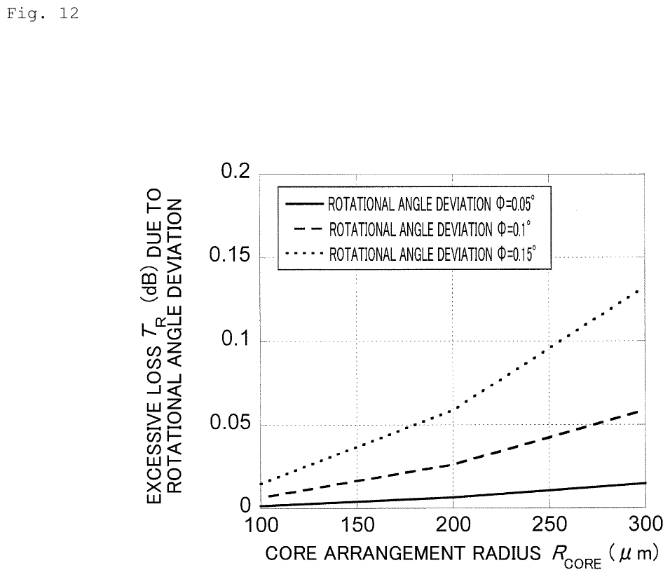

An example of the relation between the core arrangement radius Rcore and the excessive loss T_{R} due to the rotational angle deviation is shown in FIG. 12. FIG. 12 is a diagram showing the relationship between the core arrangement radius Rcore and the excessive loss T_{R} due to the rotational angle deviation when the rotational angle deviation (is 0.05 degrees, 0.1 degrees, and 0.15 degrees. The larger the core arrangement radius Rcore is, the larger the excessive loss is. However, when the mode field radii ω₁ and ω₂, for example, are 4.5 μm (MFD=9 μm), and the core arrangement radius is 250 μm or less, even if the rotation angle is shifted by 0.15 degrees, the excessive loss T_{R} due to the rotational angle deviation can be kept below 0.1 dB.

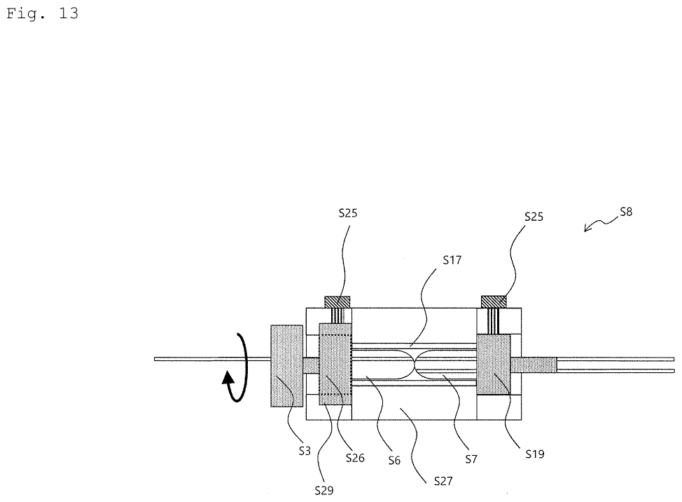

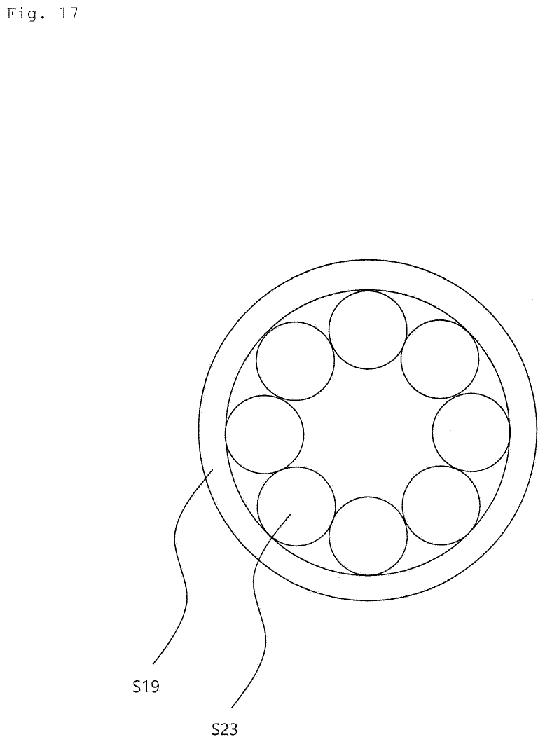

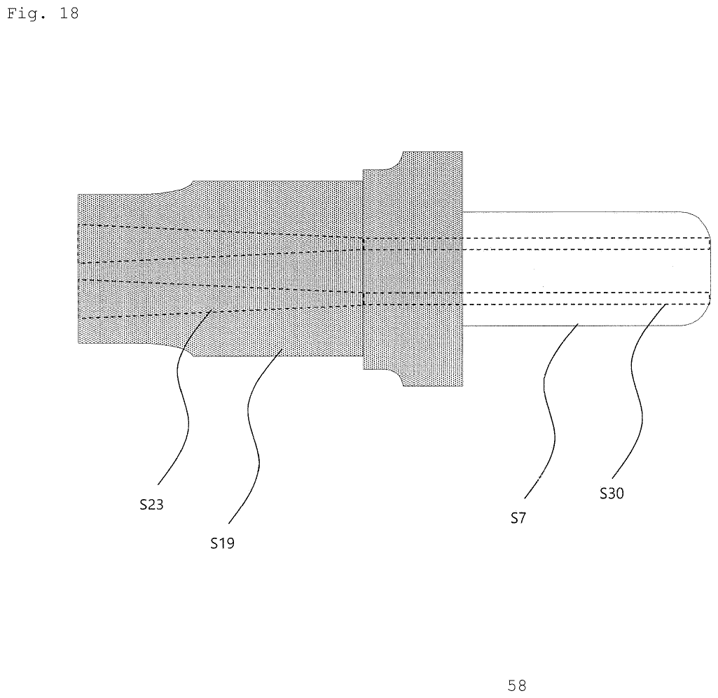

FIG. 13 is a schematic diagram showing a fitting form of the optical coupler S8 according to the Embodiment 1 of the present invention. The output-side ferrule S7 is attached to an output-side flange S19 with a notch, the output-side flange 19 is attached to a fixing jig S27 by a fixing screw S25, and the axial direction and the axial rotation direction are fixed. The input-side ferrule S6 is attached to a rotational flange S29, and a bearing S26 is provided on the rotational flange S29, which is similarly attached to a fixing jig S27 with a fixing screw S25 and fixed in the axial direction. The sleeve S17 is embedded inside the fixing jig S27, and the input-side ferrule S6 and the output-side ferrule S7 are inserted into the sleeve S17 to be axially aligned. The output-side ferrule S7 is fixed, and the input-side ferrule S6 is rotated by the rotational mechanism S5 of the bearing S26 about the center of a ferrule cylinder as an axis inside the sleeve S17. Thus, the core of the input-side optical fiber S1 inserted into the input-side ferrule S6 is rotated, and the core of the output-side optical fiber S9 opposed to the input-side optical fiber S1 is switched. For example, zirconia is used for the bearing S26. However, another material can also be used as long as the bearing is manufactured with high dimension accuracy. For example, by forming the fixing jig S27 with a frame made of a hollow metal with low rigidity, it is possible to reduce the axial deviation of the input-side ferrule S6 due to the axial deviation during rotation of the actuator. FIG. 17 is a cross-sectional view showing the output-side flange S19 with a notch attached to the output-side ferrule S7 and cut on a plane perpendicular to the longitudinal axis of the output-side flange S19. In the output-side flange S19, as shown in FIG. 17, a plurality of capillaries S23 may be inserted inside each flange. FIG. 18 is a side view showing the output-side flange S19 with a notch attached to the output-side ferrule S7. As shown in FIG. 18, the capillary S23 is disposed at a position at which the center axis aligns a fiber hole S30 of the output-side ferrule S7 attached to the output-side flange S19, and thus the output-side optical fiber S9 can be easily inserted into the output-side ferrule S7. Further, as shown in FIG. 18, the capillary S23 is tapered in the longitudinal direction, and the diameter of the tip of the capillary S23 approaches the diameter of the fiber hole S30 of the output-side ferrule S7, thereby preventing the output-side optical fiber S9 from being caught by a step when the output-side optical fiber S9 is inserted into the output-side ferrule S7 and the optical fiber can be prevented from being broken. The same applies to the rotational flange S29 attached to the input-side ferrule S6. In the present embodiment, although an example in which a plurality of capillaries are inserted inside the flange is given, the shape of the inside of the flange is not limited to this, as long as it has a shape that allows the optical fiber to be inserted into the fiber hole and that allows the optical fiber to be protected when manufacturing the optical coupler.

According to the present invention, the end faces of two ferrules in which single-core fibers are disposed parallel to the ferrule center axis and at the same distance from the ferrule center axis have a convex shape, and by butting the tips of the end faces of two ferrules so that ferrule center axes match, and by rotating one of the ferrules around the ferrule center axes, the end faces of opposite optical fibers do not come into contact with each other, and it is possible to prevent deterioration of optical properties such as splice loss due to scratches on the end faces of the optical fibers due to contact. Since a reflection amount of light can be reduced by causing the end faces of the opposite optical fibers not to be parallel with each other, a more economical optical coupler and optical switch can be provided without requiring reflection coating.

Further, according to the present invention, since one of the input-side and the output-side of the optical coupler S8 for performing optical switching is formed as an axially rotatable mechanism, energy required for the actuator S3, that is, a torque output can be made very small and power consumption can be reduced. Since an optical axis deviation amount in a direction other than axial rotation of the input-side ferrule S6 is guaranteed by the sleeve S17 in the optical coupler S8, a loss can be reduced. In addition, according to the present invention, miniaturization and economic efficiency can be achieved because a collimator or a special ant-vibration mechanism is not included and optical connection components such as a ferrule and a sleeve which are generally used are configured.

Accordingly, the present invention can provide an optical coupler and an optical switch which can achieve stable optical characteristics with low power consumption and more economically with respect to external factors such as temperature and vibration. As a result, it is possible to use the optical switch that switches a path in any facility regardless of a place in an optical line in which a single mode optical fiber of an optical fiber network is used.

### Embodiment 2

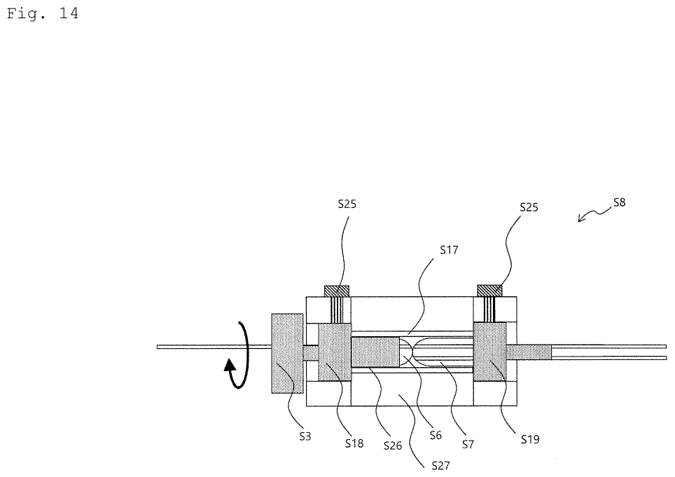

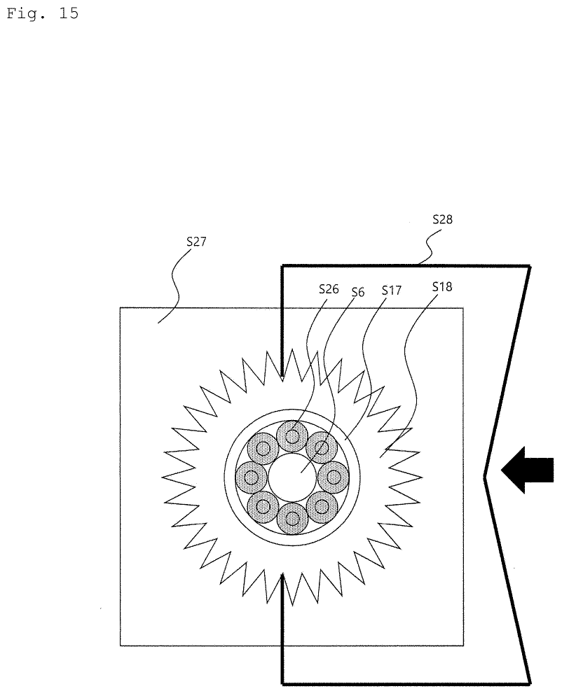

Hereinafter, a configuration and an operation of an optical switch S00 according to the present embodiment will be described specifically with reference to FIGS. 14 and 15. In the optical switch S00 according to the present embodiment, an input-side ferrule S6 of an optical coupler S8 is not attached to a rotational flange S29 but to an input-side flange S18, and a position at which the bearing S26 is provided is different from that of the optical switch S00 according to the Embodiment 1. Hereinafter, a rotational mechanism of the input-side ferrule S6 will be described. Other content to be described below are similar to those of the Embodiment 1.

FIG. 14 is a schematic diagram showing a fitting form of the optical coupler S8 according to the present embodiment. As in the Embodiment 1, the output-side ferrule S7 is attached to the output-side flange S19 with a notch, the output-side flange S19 is attached to the fixing jig S27 by the fixing screw S25, and thus the axial direction and the axial rotation direction are fixed.

The input-side ferrule S6 is attached to an input-side flange S18 with a notch. The input-side flange S18 may be attached to the fixing jig S27 by a removable fixing screw S25, and the axial direction and the axial rotation direction are fixed. By removing the fixing screw S25, the input-side flange S18 can be rotated, and the input-side ferrule S6 attached to the input-side flange S18 can be rotated accordingly. The input-side flange S18 may have a structure shown in FIG. 15 as will be described later. At this time, a fixing screw (not shown) for fixing the axial direction may be separately provided. The input-side ferrule S6 has a ferrule outer diameter S15 less than that of the output-side ferrule S7, and the bearing S26 is attached and is rotated by the rotational mechanism S5 of the bearing S26. The output-side ferrule S7 is fixed, and by making the input-side flange S18 rotatable, the input-side ferrule S6 is rotated by the rotational mechanism S5 of the bearing S26 about the center of a ferrule cylinder as an axis inside the sleeve S17. Accordingly, the core of the input-side optical fiber S1 inserted into the input-side ferrule S6 is rotated, and the core of the output-side optical fiber S9 facing the input-side optical fiber S1 is switched.

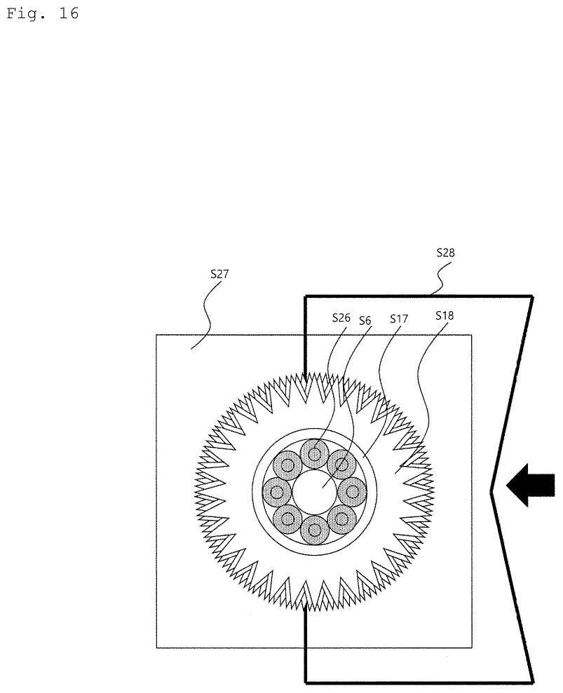

FIG. 15 is a schematic diagram showing a cross section of the input-side ferrule S6 of the optical coupler S8 according to the present embodiment. A bearing S26 is attached to the periphery of the input-side ferrule S6, and the input-side ferrule S6 can freely rotate inside the sleeve S17. Further, FIG. 15 shows an example in which a fixing spring S28 is used as a method of fixing the input-side flange S18. A groove as shown in FIG. 15 is previously provided in the input-side flange S18, and the input-side flange S18 and an input-side ferrule S6 fixed thereto are fixed by sandwiching the tip of the fixing spring S28 in the groove. The fixing spring S28 releases the fixing of the input-side ferrule S6 by applying a force in the direction of an arrow and becomes rotatable. For example, the fixing and releasing of the fixing spring S28 are interlocked with a control circuit S4 (not shown) for controlling an actuator S3, thereby enabling batch control of optical fiber switching. The shape of the outer periphery of the input-side flange S18 can be formed, as shown in FIG. 16, in a shape in which a plurality of gears are disposed so that the grooves are shifted along the longitudinal direction of the input-side ferrule S6, and thus a rotational angle can be controlled more finely. As a method of fixing and releasing the input-side flange S18, a magnet or a solenoid may be used in addition to the fixing spring S28.

As described above, according to the present invention, it is possible to provide an optical coupler and an optical switch capable of achieving stable optical characteristics with low power consumption and more economical efficiency with respect to external factors.

The above inventions can be combined as much as possible.

### INDUSTRIAL APPLICABILITY

The optical coupler and the optical switch according to the present disclosure can be applied to optical communication industries.

### REFERENCE SIGNS LIST

S00 Front-stage optical switch component
S00 Optical switch
S01 Input-side optical fiber
S02 Inter-optical switch optical fiber
S03 Rear-stage optical switch component
S03 Optical switch
S04 Output-side optical fiber
S1 Input-side optical fiber
S2 Extra long portion
S3 Actuator
S4 Control circuit
S5 Rotation mechanism
S6 Input-side ferrule
S7 Output-side ferrule
S8 Optical coupler
S9 Output-side optical fiber
S15 Ferrule outer diameter
S16 Sleeve inner diameter
S17 Sleeve
S18 Input-side flange
S19 Output-side flange
S23 Capillary
S25 Fixing screw
S26 Bearing
S27 Fixing jig
S28 Fixing spring
S29 Rotational flange
S30 Fiber hole

1. An optical coupler comprising:
a first ferrule in which core centers of one or a plurality of single-core fibers are disposed on the same circumference from a center in a ferrule cross section, and which has an end face of a convex spherical shape in a direction of a ferrule center axis together with an end face of the single-core fiber;
a second ferrule in which core centers of the plurality of single-core fibers are disposed on a circumference having the same diameter as the circumference on which the core centers of the single-core fibers are disposed in the first ferrule from the center in the ferrule cross section, and which has an end face of a convex spherical shape in the direction of the center axis of the ferrule together with the end face of the single-core fiber; and
a cylindrical sleeve that has a hollow portion into which the first and second ferrules are inserted such that the ferrule center axes of the first ferrule and the second ferrule match, and the convex spherical end faces are opposite to each other, and in which a predetermined gap is provided between an outer diameter of each of the first ferrule and the second ferrule and an inner diameter of the hollow portion so that the first ferrule and the second ferrule are able to rotate.

2. The optical coupler according to claim 1,
wherein in each of the first ferrule and the second ferrule, an angle formed by a cross section perpendicular to the ferrule center axis and an end face of the single-core fiber is 4.5 degrees or more.

3. The optical coupler according to claim 1,
wherein a gap between the end face of the single-core fiber of the first ferrule and the end face of the single core fiber of the second ferrule whose optical axis matches with the single-core fiber is 22 μm or less.

4. The optical coupler according to claim 1,
wherein a distance of the core center of each single-core fiber in the first ferrule and the second ferrule from the ferrule center is 250 μm or less.

5. The optical coupler according to claim 1,
wherein in each of the first and second ferrules,
a radius of curvature in the convex spherical shape is 0.5 mm to 3.2 mm.

6. An optical switch comprising:
the optical coupler according to claim 1; and
a rotational mechanism configured to rotate one of the first and second ferrules of the optical coupler about the ferrule center axis.

7. The optical switch according to claim 6, further comprising:
an actuator configured to rotate the rotational mechanism at a given angular step and stop the rotational mechanism at an arbitrary angular step; and
a bearing forming the rotational mechanism.
